(19) United States
(12) Patent Application Publication
(10) Pub. No.: US 2005/0032505 A1
(43) Pub. Date: Feb. 10, 2005

(54) Calling plan time display and method of display for a cellular phone

(76) Inventor: Richard C. Himelhoch, Highland Park, IL (US)

Correspondence Address: Richard C. Himelhoch, 26 Insignia Court, Highland Park, IL, 60035, US

(21) Appl. No.: 10/885,883

(22) Filed: Jul. 7, 2004

Related U.S. Application Data
(60) Provisional application No. 60/485,201, filed on Jul. 7, 2003.

(51) Int. Cl. H04M 11/00

(52) U.S. Cl. 455/405; 455/407

(57) ABSTRACT

A cellular phone that provides a display of the minutes used and/or remaining during a current cycle of a category of minutes provided in a calling plan. The display allows the user to immediately know if further use will incur additional fees beyond the monthly base fees. Additionally, A method for monitoring and displaying on a cellular phone the number of minutes used and/or remaining in a cellular phone calling plan. The method comprising the steps of: providing a cellular phone; inputting an initial start time for a repeating time cycle of a calling plan; inputting a time period for the repeating time cycle; providing a designated amount of time for a first category of time in the calling plan for the repeating time cycle; monitoring phone usage of the first category of time; and, displaying an indication of one of an amount of time used of the designated amount of time for the first category of time and an amount of time remaining of the designated amount of time for the first category of time in a current repeating time cycle.

### RELATED APPLICATIONS

This application claims the benefit of U.S. Provisional Application No. 60/485,201, filed Jul. 7, 2003.

### TECHNICAL FIELD

The present invention is generally related to a cellular phone that quickly and easily provides an indication of the number of minutes used and/or remaining in a calling plan, and more particularly to a cellular phone that monitors and displays the number of minutes used and/or remaining in each category of a calling plan in real time on the cellular phone display.

### BACKGROUND OF THE INVENTION

One of the more frustrating aspects of owning and using a cellular phone is keeping track of the available minutes remaining in a calling plan offered by a cellular phone service provider. Going over the allotted minutes in a month can add significant amounts to the monthly fees charged by the provider.

Each cellular phone service provider typically offers a number of different plan options on a monthly subscription basis. For example, for a first set monthly price a user may be entitled to 250 minutes of anytime use (this typically includes both calls made by the cellular phone owner as well as those received) plus practically limitless weekends and nights (i.e., after a predetermined time). However, for a second set monthly price, the user may be entitled to 500 minutes of anytime use plus the limitless weekends and nights. Use of the phone beyond the plan minutes (e.g., over 250 for the first plan and 500 for the second plan) typically incurs additional charges per minute of use (over the monthly rate), with any use under one minute counting as a full minute.

When operating a cellular phone to make a call, it is not possible to determine how many minutes are remaining in the plan for the specified time period (typically one month). Some phones are believed to be capable of keeping track of the total number of minutes used. However, it is difficult to get such information from the phone and the user would have to reset the timer upon the beginning of each billing cycle. Moreover, such timers do not distinguish the type of minutes used (i.e., anytime minutes from weekend/night minutes). The only method of determining exactly how many minutes are used up or remaining for a cellular phone calling plan in a given time period is to call the cellular service provider, or to log onto and view information from an Internet web site, for those cellular phones that have access to the Internet. One such system is provided by SPRINT®, which allows a user to log onto the Internet and then navigate to a site that permits the user to view information concerning the minutes used in a plan for a particular month. The SPRINT® system requires the user to enter a log in password to access such information. This can be time consuming.

### SUMMARY OF THE INVENTION

The present invention is directed to a cellular phone that can be programmed to monitor and display the number of minutes used and/or remaining in a calling plan for a current cycle. The display could be permanently included as part of the main screen of the phone (i.e., it is automatically displayed by the cellular phone on the main screen), or easily accessibly through a button or menu display icon, or automatically displayed in response to some prompt (e.g., dialing a number, or completing a call). The cellular phone could also keep track of unused minutes on a monthly basis and/or minutes (and costs associated with such minutes) used over the allowed plan minutes in each cycle. This last function would enable a user to better evaluate their phone plan needs.

In one alternative embodiment, the cellular phone service provider can (and does for billing purposes anyway) monitor the cellular phone use, and wirelessly provide the cellular phone with data to allow the cellular phone to display the number of minutes used and/or remaining in a calling plan for the current cycle. That is, when the phone is turned “on” it may emit a signal indicating that it is available for calls to the cellular phone service provider, which in turn, can wirelessly send data (e.g., time use in a plan during the current cycle) which can be displayed on the cellular phone display. In this embodiment, the cellular phone itself does not have to maintain the used minutes in memory or perform any calculations. It is contemplated in this embodiment that this function (i.e., wirelessly providing plan time information) is done automatically, without requiring the user to actively log onto and navigate through the Internet to obtain such information.

The invention can be incorporated in any standard cellular phone. When turned “on” most cellular phones display a main menu screen from which a user (utilizing the buttons on the phone) can toggle or scroll through a number of different functions provided by the phone. The main screen typically provides certain information on a constant (i.e., permanent—when the main screen is being displayed) basis, such as, for example, an indication of the power remaining in the battery and the current time. The present invention allows the cellular phone to display or otherwise provide an indication of the number of minutes used and/or remaining in a calling plan during the current billing cycle. This indication could be on a screen that is selected from the main screen, or can be permanently placed on the main screen with the other information typically found there. Preferably the display will provide the start and end dates of the current cycle, the selected (or designated) plan minutes for a category of time that is currently available (e.g., anytime minutes; night/weekend minutes) and/or the selected plan minutes for a category chosen by the user, and an indication of the used and/or remaining minutes of the monthly allotted or designated minutes in the relevant or chosen category of the calling plan. Thus, a user can look at the display and immediately know how much time is left in the plan (and therefore how long they can stay on the phone without incurring additional charges), and when the next cycle begins. Alternatively, the information can be displayed after dialing a number and/or immediately after a phone call for a set period of time.

In a preferred embodiment, a cellular phone is initially programmed by the user to (1) indicate the start date of a calling plan provided by a cellular phone service provider (or for plans already in progress, the start date of the current or next cycle); (2) the length of time of each cycle (e.g., 30 days or 1 month); (3) the number of designated or allotted minutes in a first category of time, usually set forth in minutes (e.g., anytime minutes) for each cycle; and (4) the number of designated minutes in a second category of time or any further categories of time for each cycle (e.g., weekend/night minutes—This is optional and typically would only be used if there is more than one category of time in the plan. Additionally, if the second category is limitless minutes, or virtually limitless minutes, the user may only want to track the first category of time). Messages can be shown on the display of the cellular phone to prompt and guide the user to input the correct information. Alternatively, instead of requiring the user to input this information, some or all of this information could be inputted by the cellular phone service provider upon activation of a service plan. Once inputted, the cellular phone monitors the minutes used in the inputted categories and keeps track of or calculates the minutes used and/or the minutes remaining in the current cycle. In this regard, it functions as a counter during the cycle. When the next cycle begins, the counter is reset and begins again to monitor the number of minutes used and the number of minutes remaining for each category.

The cellular phone (or service provider in the embodiment where the service provider sends some or all of the data described) could also include a memory to store the monthly usage with respect to the plan time periods. This information would enable a user to better tailor the appropriate plan that fits their typical monthly cell phone use.

Additionally, the cellular phone can be provided with a visible or audible alarm or warning to provide an indication of when a user is getting close to or exceeding the allotted minutes in a plan. Moreover, the cell phone may provide an audible indication of the minutes used and/or remaining in a plan. This may be done in addition to or instead of visually displaying the indication.

In one embodiment of the invention, a cellular phone system configured to provide information relating to time in a calling plan comprises a cellular phone having a housing containing a display and a plurality of input keys. The cellular phone is configured to provide an indication of the time remaining for a first category of time provided in a calling plan during a cycle of the calling plan. The first category of time is typically set forth as a number of minutes. The indication of time remaining for a first category of time provided in a calling plan during a cycle of the calling plan is displayed on the display of the cellular phone. Preferably, the indication is permanently part of a main screen page appearing on the display. The cellular phone of the system can be configured to also provide a starting time of a current cycle in the calling plan and/or an end time of the current cycle.

The cellular phone can include circuitry for monitoring use of the cellular phone and calculating the indication of time remaining for a first category of time provided in a calling plan during a cycle of the calling plan. Additionally, the cellular phone can further comprise circuitry for providing an indication of time remaining for a second category of time provided in the calling plan during a cycle of the calling plan, or for a plurality of subsequent categories. The monitoring step or function could include: (1) determining when the cellular phone is being used; (2) checking the current time and date and determining which category of time the use is occurring in; and (3) adding the use time in each category throughout the cycle (and resetting the counter at the beginning of the next cycle).

The cellular phone can further comprise a visual alarm indicating one of nearing a designated time for the first category of time and/or exceeding the designated time for the first category of time in a current cycle. Alternatively, the cellular phone can comprise an audible alarm indicating one of nearing a designated time for the first category of time and exceeding the designated time for the first category of time in a current cycle. In either case, the alarm could be activated upon reaching a predetermined amount of time of phone usage in the current cycle of time (e.g., five minutes before reaching the designated minutes in the plan per cycle).

In another embodiment of the invention, a cellular phone system is configured to provide information relating to an amount of time (e.g., number of minutes) remaining of a designated time allotment for a current cycle in a cellular phone calling plan. The system comprises a cellular phone including a housing having a display and a plurality of input keys, and circuitry in the housing configured to monitor an amount of time of use of the cellular phone for a first category of time during a current cycle of a calling plan and provide an indication of an amount of time remaining of the designated time allotment for the first category of time in the current cycle to a user of the cellular phone. The circuitry can be, for example, part of an overall circuit used by the cellular phone, or may be in the form of a processor—and any associated components, such as memory—programmed to carry out the functionality described. The indication of the amount of time remaining of the designated time allotment in the current cycle is preferably displayed on the display. Preferably, the start date of the current cycle, the end date of the current cycle, and the designated time allotment for the first category of time are also displayed on the display.

The circuitry in the cellular phone can be further configured to store in a memory one of an amount of unused time of the designated time allotment in a cycle and an amount of time exceeding the designated time allotment in a cycle for each cycle of the calling plan. This information could be later called up by the user.

The circuitry in the cellular phone can be further configured to monitor an amount of time of use of the cellular phone for a second category of time during a current cycle of a calling plan and provide an indication of an amount of time remaining of the designated time allotment for the second category of time in the current cycle to a user of the cellular phone.

In yet a further embodiment of the invention, a method for monitoring and displaying on a cellular phone the number of minutes used and/or remaining in a cellular phone calling plan comprises the steps of: providing a cellular phone, inputting an initial start time (e.g., a start date) for a repeating time cycle of a calling plan, inputting a time period for the repeating time cycle (e.g., each cycle equals 30 days), providing a designated amount of time for a first category of time in the calling plan for the repeating time cycle (e.g., 250 anytime minutes per cycle), monitoring phone usage of the first category of time (i.e., keeping track of the time used) and, displaying an indication of one of an amount of time used of the designated amount of time for the first category of time and an amount of time remaining of the designated amount of time for the first category of time in a current repeating time cycle (the amount of time remaining is a simple calculation of subtracting the time used from the designated amount). The displaying step is preferably done in substantially real time on a display in the cellular phone. The method could further include displaying the start date, end date and designated amount of time for the first category of time on the display of the cellular phone.

The method can further include the steps of: providing a designated amount of time for a second category of time in the calling plan for the repeating time cycle, monitoring phone usage of the second category of time and, displaying an indication of one of an amount of time used of the designated amount of time for the second category of time and an amount of time remaining of the designated amount of time for the second category of time in a current repeating time cycle.

Additionally, the method may include providing an alarm if the monitored phone usage in a current cycle reaches a predetermined amount of time. The predetermined time could be an amount of time near the end of the designated amount of time or at or exceeding the designated amount of time.

In yet another embodiment of the invention, the cellular phone can be programmed to keep track of text messaging and to display the amount of use of such messaging. Further, the cellular phone can provide the user with an estimated cost for any over usage of the phone during a cycle, or the amount of roaming or other charges incurred during a particular call.

Moreover, touch screen technology may replace physical input keys in some newer cellular phones and are considered equivalent to depressing a physical key.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a front view of a cellular phone providing an indication of the number of minutes used and/or remaining in a cellular phone calling plan during a current cycle in accordance with the present invention; and,

FIG. 2 is a flow chart of the process for obtaining the required initial data to monitor use of minutes in a cellular phone calling plan and for monitoring and displaying the number of minutes used and/or remaining in the plan.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

Most cellular phone plans provide a set number of “anytime” phone minutes for a set price on a monthly basis. Such “anytime” minutes can be used throughout the day without incurring any additional costs. Typically, the higher the set price, the more “anytime” minutes provided on a monthly basis. Some plans also include additional minutes for use during specified time periods, such as weekends or nights. The present invention provides a cellular phone system that monitors the minutes used in a designated time period and provides (preferably through the display) an indication of the amount used and/or the remaining minutes left in the plan.

The cellular phone can also keep track of unused minutes on a monthly basis and/or keep track of the minutes (and costs) that exceed the monthly plan. This information can be utilized to determine if the owner of the phone is on the correct plan for their personal typical phone use.

Most cellular phones currently available already provide the current time and date. Some have calendar functions and can even store messages associated with a particular time and date. This functionality can be utilized in the calculations for providing the indication of the amount used and/or remaining during a current cycle.

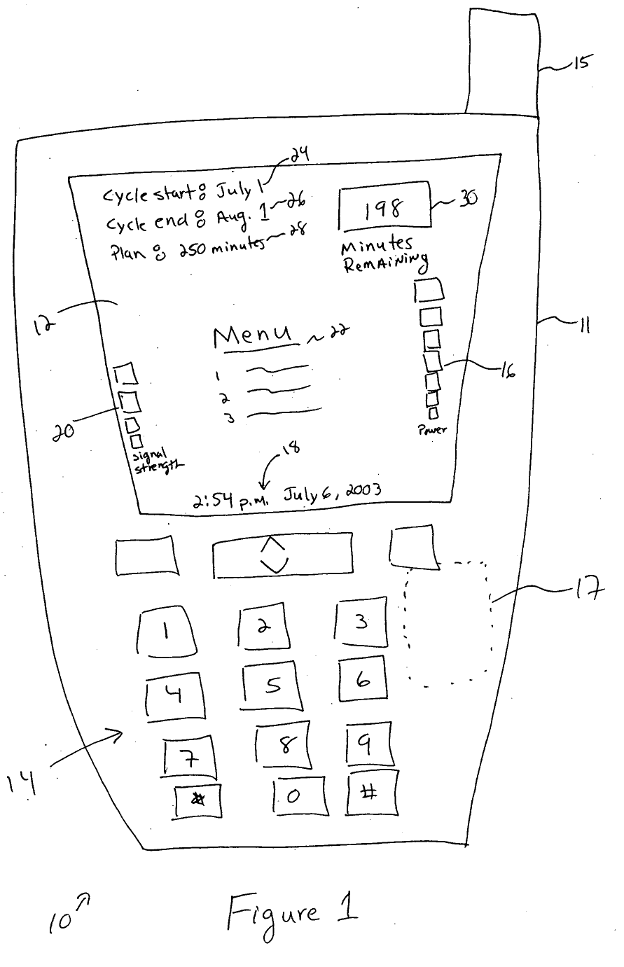

Referring to FIG. 1, a cellular phone system 10 is provided having a housing 11 with a display 12 and a plurality of input keys 14 (the cellular phone shown is of a unitary body design; however, the invention is not limited to this design and can be utilized with other cellular phone types, such as flip up type cellular phones). An antenna 15 extends from the top of the cellular phone 10. When the cellular phone is turned “on” a main screen page is typically shown on the display 12. Other pages may be available by scrolling through the main page and/or utilizing various input keys 14.

Typically, the main screen page on the display will provide a variety of information or data on a substantially constant or permanent basis (i.e., when the main screen is displayed). For example, the main screen page may provide an indication of the remaining charge or power in the battery 16; the current time and date 18, the strength of the carrier signal 20; and scrollable menu options 22. Different cellular phones may provide similar or different items of information on the main screen.

In accordance with the present invention, the display 12 includes information on the main screen page that provides an indication of the time used and/or remaining in a calling plan for a given category of time for a given time period or cycle (e.g., a billing cycle). In the preferred embodiment shown in FIG. 1, the display 12 includes the start time or date 24 of a current billing cycle in a plan, the end date 26 of the current cycle, and the number of minutes in a first category of time 28 provided in the plan for the base monthly charge. Primarily, the display also includes an indication of the number of minutes used and/or remaining in the first category of time for the current cycle 30. While it is preferred to show the number of minutes remaining, it is possible to show the number of minutes used, typically with an indication of the number of minutes in the plan, to provide a similar indication of the time remaining. Moreover, both numbers could be displayed (i.e., time used and time remaining) or the cellular phone can be programmed to allow the user to toggle between which one is shown. While the information is preferable displayed on the main screen page, it may be shown on another page, when dialing or when in use, or when an input key is pressed.

The cellular phone 10 is preferably provided with programmable circuitry 17 (shown in phantom) to allow the phone to be programmed to monitor phone use and calculate the minutes used and/or remaining information. One alternative, is to hard wire the functionality described herein. Another alternative, is to provide some or all of the information by the cellular phone service provider or some other party as wireless information received by the cellular phone 10. The cellular phone can then display the received information. In this embodiment, the information is provided by the service provider or other party when the cellular phone is turned on without any prompting from the user of the cellular phone. That is, the cellular phone user does not have to log onto the internet and navigate to location having the desired information.

The cellular phone 10 is typically activated when the user signs up with a cellular phone service provider. Such service providers typically have a number of different service plans having different services for different prices. For example, an owner of a cellular phone may sign up for a two year plan with a monthly base charge of $29, $39, $49 etc. The $29 plan may include 150 minutes of anytime calling as a first category of minutes (or more generically “a first category of time”—most plans today are calculated in minutes, however, other units of time may be used in the future) in the plan, and 5000 minutes of night (during a certain designated time period, e.g., 10:00 p.m. through 6:00 a.m.) and weekend minutes as a second category of minutes in the plan. The $39 plan may include 250 anytime minutes in the first category of minutes, and 5000 minutes of night/weekend minutes in the second category. Similarly, the $49 plan may provide 500 minutes in the first category and 5000 minutes in the second category. Each of the plans will typically charge for each minute the user of the cellular phone 10 goes over the designated minutes provided for the base monthly charge.

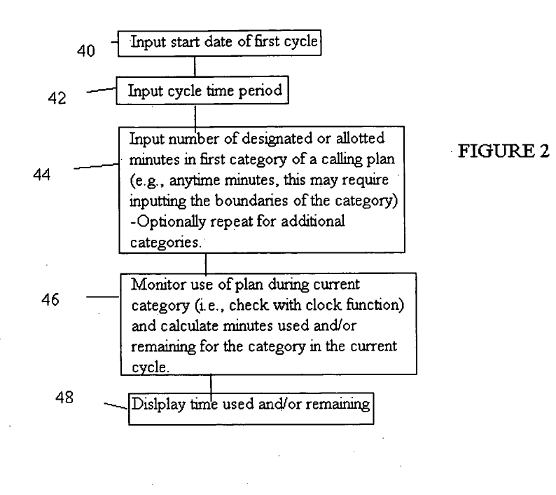

The present invention allows the user of the cellular phone to easily determine how many minutes remain before an additional charge (i.e., beyond the base monthly charge) will be incurred. Referring to FIG. 2, preferably the user or owner of the cellular phone will input a start time or date of a selected cellular phone plan 40. The user would then input the time period for each cycle 42. For most current plans, a typical time period for a cycle is one month or thirty days.

The user would then enter the number of minutes (i.e., the designated or allotted minutes) provided by the plan for each cycle for a first category of time in the calling plan 44 (e.g., anytime minutes, or night/weekend minutes etc.). This may require inputting additional information to define the first category, such as the hours/days the first category of time is usable or in effect (e.g., from 6:00 a.m.-10:00 p.m. Monday through Friday). The inputted information can be stored in a memory provided in the circuitry 17 of the cellular phone 10. Additionally, if other categories of time are part of the calling plan, this step 44 can optionally be repeated until all categories are accounted for (such other categories may also include text messaging or other services that can be provided for a set periodic fee but which have additional charges if the user goes over the set fee). The cellular phone 10 is preferably programmed to provide messages to prompt and guide the user in inputting the desired information.

The cellular phone 10 can monitor use of the phone during a cycle, and utilizing the inputted information and the current time and date information maintained or provided to the cellular phone 10, the cellular phone 10 can calculate the minutes used and/or remaining for each category of time in the plan 46. In this regard, the phone acts like a counter or timer keeping track of the minutes. The cellular phone 10 then displays the time used and/or remaining (i.e., 30) for the category at issue (or for all the categories at once, or forjust a desired category—the input keys 14 could be used to select which of these options the user wants to display), and optionally other items of information (e.g., 24, 26 and 28) on the display 48. When the end of a cycle is reached, the minutes used and/or remaining information is reset and the display will provide the current indication of minutes used and/or remaining for the new current cycle.

In addition to the above, the cellular phone can store the monthly usage in a memory and provide the user with a profile of how many minutes were left unused or went over (and additional cost associated therewith) for each cycle. This information can enable the user to better select a plan that suits their use.

Additionally, the cellular phone can be programmed to provide the number of minutes used and the cost or fee for each minute used over the designated amount for a plan during a cycle. This may require inputting additional information generally relating to such charges.

The cellular phone 10 could also be provided with some form of visible or audible alarm to indicate to the user when the user is approaching and/or exceeding the designated minutes in a category of time for a calling plan in a cycle. For example, at a predetermined number of minutes prior to reaching the designated number of minutes in a plan, the indication of the number of minutes used and/or remaining in a plan 30 could be flashing. Other visual alarms could be utilized on the display. Additionally, or instead of a visual alarm, the phone may emit an audible alarm, such as a tone, beep or speech.

Some or all of the functionality described can be implemented by hardware, or as a program on a processor or similar type chip maintained in the cellular phone.

As set forth above, in one embodiment, some or all of the data necessary to provide the indication of the minutes used and/or remaining in the plan may be wirelessly provided by the cellular phone service provider (or another party). This can be accomplished, for example, each time the cellular phone is turned on. The cellular phone can send a signal that it is “on” to the cellular phone service provider which can then provide the phone with the data. In this manner, some or all of the circuitry or software needed for implementing the functionality described herein, can be associated with the cellular phone service provider (or other party) rather than being in the cellular phone. It is contemplated that such information is provided to the cellular phone without the requirement for user interaction (i.e., no need to log onto the Internet or other network to obtain such information). Alternatively, the phone can be programmed to have a single command or button to implement this functionality to receive the data from the service provider (again, there is no requirement to log onto the Internet)

The above method and cellular phone allows for monitoring and providing an indication of the time used and/or remaining for a category of time in a calling plan for most or all currently available plan options for most or all cellular phone service providers. However, modifications can be easily implemented to allow the phone to monitor plans that differ from the typical monthly plan having a set or designated number of minutes (before incurring additional charges) for a category of time. For example, a simple software change can be used to mimic more complicated plans that vary the number of minutes based on some criteria, or which change over time or from cycle to cycle.

The cellular phone 10 could be programmed to compensate for out of area (i.e., “roaming”) calls which may have a different price structure than the typical category of time use in a local area or cell. The phone 10 could also keep track of the charges or minutes used each month and display that information at request.

The cellular phone could be provided with a dedicated button or screen icon to get to the desired time used and/or time remaining display. Alternatively, the dedicated button or screen icon could prompt a speech indication of the time used and/or time remaining.

It will be understood that for cellular phones that monitor monthly over or under usage (with respect to the category(ies) of time in the calling plan), the counter function would continue even after reaching the designated number of minutes in the plan.

The present invention allows the user to quickly and easily determine the amount of time remaining on a calling plan and avoid or limit charges associated with going over the allotted time. It also allows a user to more fully utilize the allotted time. That is users that habitually limit their discussion time in an overabundance of caution to avoid going over the allotted time will have a better sense of how close they are to the cutoff and can thus not leave minutes on the table.

Additionally, it is contemplated that the time remaining can be an estimate, with the more accurate time being kept by the service provider for billing purposes. In this case, the program can be conservative in the estimate or have a built in fudge factor (e.g., start a cycle with two-three minutes counted right at the start) to help ensure that the user does not go over the allotted time by accident.

It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A cellular phone system configured to provide information relating to time in a calling plan comprising:
a cellular phone having a housing containing a display and a plurality of input keys wherein the cellular phone provides an indication of the time remaining for a first category of time provided in a calling plan during a cycle of the calling plan.

2. The cellular phone system of claim 1 wherein the indication of time remaining for a first category of time provided in a calling plan during a cycle of the calling plan is displayed on the display of the cellular phone.

3. The cellular phone system of claim 2 wherein the indication of time remaining for a first category of time provided in a calling plan during a cycle of the calling plan is permanently part of a main screen page appearing on the display.

4. The cellular phone system of claim 2 wherein the display also provides a starting time of a current cycle in the calling plan.

5. The cellular phone system of claim 4 wherein the display also provides an end time of the current cycle.

6. The cellular phone system of claim 1 wherein the cellular phone includes circuitry for monitoring use of the cellular phone and calculating the indication of time remaining for a first category of time provided in a calling plan during a cycle of the calling plan.

7. The cellular phone system of claim 1 wherein the cellular phone further provides an indication of time remaining for a second category of time provided in the calling plan during a cycle of the calling plan.

8. The cellular phone system of claim 1 further comprising a visual alarm indicating one of nearing a designated time for the first category of time and exceeding the designated time for the first category of time in a current cycle.

9. The cellular phone system of claim 1 further comprising an audible alarm indicating one of nearing a designated time for the first category of time and exceeding the designated time for the first category of time in a current cycle.

10. The cellular phone system of claim 1 wherein the cellular phone wirelessly automatically receives data relating to the indication of the time remaining for a first category of time provided in a calling plan during a cycle of the calling plan

11. A cellular phone system configured to provide information relating to an amount of time remaining of a designated time allotment for a current cycle in a cellular phone calling plan comprising:
a cellular phone including
a housing having a display and a plurality of input keys;
circuitry in the housing configured to monitor an amount of time of use of the cellular phone for a first category of time during a current cycle of a calling plan and provide an indication of an amount of time remaining of the designated time allotment for the first category of time in the current cycle to a user of the cellular phone.

12. The cellular phone system of claim 11 wherein the indication of the amount of time remaining of the designated time allotment in the current cycle is displayed on the display.

13. The cellular phone system of claim 12 wherein the start date of the current cycle is displayed on the display.

14. The cellular phone system of claim 13 wherein the end date of the current cycle is displayed on the display.

15. The cellular phone system of claim 11 wherein the circuitry is further configured to store in a memory one of an amount of unused time of the designated time allotment in a cycle and an amount of time exceeding the designated time allotment in a cycle for each cycle of the calling plan.

16. The cellular phone system of claim 11 wherein the circuitry is further configured to monitor an amount of time of use of the cellular phone for a second category of time during a current cycle of a calling plan and provide an indication of an amount of time remaining of the designated time allotment for the second category of time in the current cycle to a user of the cellular phone.

17. A method for monitoring and displaying on a cellular phone the number of minutes used and/or remaining in a cellular phone calling plan comprising the steps of:
providing a cellular phone;
inputting an initial start time for a repeating time cycle of a calling plan;
inputting a time period for the repeating time cycle;
providing a designated amount of time for a first category of time in the calling plan for the repeating time cycle;
monitoring phone usage of the first category of time; and,
displaying an indication of one of an amount of time used of the designated amount of time for the first category of time and an amount of time remaining of the designated amount of time for the first category of time in a current repeating time cycle.

18. The method of claim 17 further comprising the step of:
displaying the indication of one of an amount of time used of the designated amount of time for the first category of time and an amount of time remaining of the designated amount of time for the first category of time in a current repeating time cycle, in substantially real time on a display in the cellular phone.

19. The method of claim 17 further comprising the steps of:
providing a designated amount of time for a second category of time in the calling plan for the repeating time cycle;
monitoring phone usage of the second category of time; and,
displaying an indication of one of an amount of time used of the designated amount of time for the second category of time and an amount of time remaining of the designated amount of time for the second category of time in a current repeating time cycle.

20. The method of claim 17 further comprising the steps of:
displaying a start date of the current repeating time cycle on the display of the cellular phone; and,
displaying an end date of the current repeating time cycle on the display of the cellular phone.

21. The method of claim 17 further comprising the step of:
providing an alarm if the monitored phone usage in a current cycle reaches a predetermined amount of time.

22. The cellular phone system of claim 7 wherein the circuitry further calculates additional charges incurred under the calling plan in excess of a set cycle charge for a current cycle of the calling plan.
